(19) United States
(12) Patent Application Publication
(10) Pub. No.: US 2011/0124206 A1
(43) Pub. Date: May 26, 2011

(54) Board-To-Board Connector

(75) Inventor: Yuki Goto, Yamato (JP)

(73) Assignee: Molex Incorporated, Lisle, IL (US)

(21) Appl. No.: 12/910,388

(22) Filed: Oct. 22, 2010

(30) Foreign Application Priority Data
Oct. 22, 2009 (JP) 2009-242909

(51) Int. Cl. H01R 12/70

(52) U.S. Cl. 439/65

(57) ABSTRACT

A board-to-board connector is disclosed. The board-to-board connector comprises a first connector and a second connector. The first connector has a first housing and a first terminal, and is configured to be mounted on a first board. The first terminal is fitted in the first housing. The second connector has a second housing and a second terminal. The second terminal is fitted in the second housing and is configured to make contact with the first terminal. The second connector is configured to be mounted on a second board so as to be engaged with the first connector. When the first connector and the second connector are engaged together, a plane where the first board is present intersects a plane where the second board is present.

### REFERENCE TO RELATED APPLICATIONS

The Present application claims priority to prior-filed Japanese Patent Application No. 2009-242909, entitled “Board-To-Board Connector,” and filed 22 Oct. 2009, the contents of which is fully incorporated in its entirety herein.

### BACKGROUND OF THE PRESENT APPLICATION

The Present application relates, generally, to a board-to-board connector.

Typically, in order to connect a battery or the like to an electrical device or apparatus, an or electronic device or apparatus, or the like, a proposal has been made to use a type of connector in which one connector has a flat plate-like terminal, a terminal of the other connector is provided with a pair of connection members, and the pair of connection members clamps the flat plate-like terminal from both sides thereof, whereby connection between the terminals is maintained. An example of a conventional connector is described in Japanese Patent Application No. 2003-433509.

Additionally, FIG. 7 is a cross-sectional view illustrating a structure of a conventional connector. Referring to FIG. 7, a board connector has a housing 811 and is mounted on a board 891 such as a circuit board that is provided in a casing 892 of an electrical device or apparatus, an electronic device or apparatus, or the like. The board connector has a terminal 861 which is engaged by fitting with a concave engagement portion 813 formed in the housing 811.

The terminal 861 is provided with a solder tail portion 862, and a back surface of the solder tail portion 862 is connected, by a solder 881, to a connection pad (not shown) which is formed on a top surface of the board 891. In this way, the terminal 861 is electrically connected to a non-illustrated conductive trace of the board 891 via the connection pad, and a whole body of the board connector is physically fixed to the board 891.

The terminal 861 is also provided with a pair of connection members 863 which is connected to a counterpart terminal of a non-illustrated counterpart connector. Each of the connection members 863 is an elongated plate-like member extending from a body portion of the terminal 861 and has spring-like properties. Each of the connection members 863 is formed with a convex contact portion 864 at the proximity of a free end thereof so as to protrude towards the other connection member 863. Moreover, each of the connection members 863 extends along an inner wall of a slit-like opening portion 814 formed in the housing 811, and is arranged so that at least a distal end of the convex contact portion 864 is projected into a space of the opening portion 814.

When the board connector is engaged by being fitted with the counterpart connector, the plate-like counterpart terminal comes into the slit-like opening portion 814, which is then clamped by the pair of connection members 863 from both sides thereof. At this time, the convex contact portions 864 of the connection members 863 are squeezed into both one and the opposite surface of the counterpart terminal, so that secure contact between the counterpart terminal and the terminal 861 is achieved.

However, in the above-described connector, when an external force is applied to the casing 892 and/or a member such as a board mounting the counterpart connector thereon, the solder 881 may be broken so that the solder tail portion 862 is detached from the surface of the board 891. As a result, a whole body of the connector may be separated from the board 891.

For example, when an external force capable of disengaging the connector from the counterpart connector is applied to the counterpart connector, a rightward urging force, in the figure, acts on the convex contact portions 864 of the connection members 863. That is to say, the force is exerted in a direction to pull and separate the connection members 863 from the surface of the board 891, which direction is perpendicular to the surface of the board 891. In this case, since the perpendicular feet, which are drawn from the convex contact portions 864 to the surface of the board 891, are distant from the solder tail portion 862, a rotational moment will act on the solder 881 at which the solder tail portion 862 is secured to the surface of the board 891 in addition to the force perpendicular to the surface of the board 891. For this reason, the solder 881 will be broken, and the solder tail portion 862 will be detached from the surface of the board 891.

### SUMMARY OF THE PRESENT APPLICATION

Therefore, it is an object of the Present application to solve the above-described problems encountered by the conventional connector and to provide a board-to-board connector having a configuration such that the perpendicular feet, which are drawn from a contact point of first and second terminals to first and second boards, are respectively located within an area for connection of a fixing bracket of the first connector to the first board and within an area for connection of a fixing bracket of the second connector to the second board. As a result, it is made possible to maintain a secure contact state between the first and second terminals even when an external force is applied thereto. Thus, the first and second connectors are prevented from being removed from the first and second board, respectively. Accordingly, the board-to-board connector is able to facilitate an operation of fitting the first and second connectors so that they are engaged together and provide high reliability for the board-to-board connector.

Therefore, a board-to-board connector according to the Present application includes a first connector having a first housing made of an insulating material and a first terminal fitted in the first housing, the first connector being configured to be mounted on a first board; and a second connector having a second housing made of an insulating material and a second terminal fitted in the second housing and configured to make contact with the first terminal, the second connector being configured to be mounted on a second board so as to be engaged with the first connector, wherein: when the first connector and the second connector are engaged together so that a plane where the first board is present intersects a plane where the second board is present, the perpendicular feet, which are drawn from a contact point of the first and second terminals to the first and second boards are respectively located within an area for connection of a fixing bracket of the first connector to the first board and within an area for connection of a fixing bracket of the second connector to the second board as viewed in a side view of the first and second connectors.

The board-to-board connector according to the Present application has a configuration such that the fixing bracket of the first connector includes a first fixing bracket and a second fixing bracket which are fitted to the first housing, and the area for connection of the fixing bracket to the first board is an area that extends from a distal end of an area for connection of the first fixing bracket to the first board to a distal end of an area for connection of the second fixing bracket to the first board, as viewed in the side view of the first connector; and the fixing bracket of the second connector includes a third fixing bracket and a fourth fixing bracket which are fitted to the second housing, and the range of connection areas of the fixing bracket to the second board is an area that extends from a distal end of an area for connection of the third fixing bracket to the second board to a distal end of an area for connection of the fourth fixing bracket to the second board, as viewed in the side view of the second connector.

The board-to-board connector according to the Present application has a configuration such that the first fixing bracket is a solder tail portion of the first terminal, and the second fixing bracket is a part of the first auxiliary bracket fitted to the first housing; the third fixing bracket is a solder tail portion of the second terminal, and the fourth fixing bracket is a part of the second auxiliary bracket fitted to the second housing; and the perpendicular feet, which are drawn from the contact point of the first and second terminals to the first and second boards are respectively located within an area for connection of the first auxiliary bracket to the first board and within an area for connection of the second auxiliary bracket to the second board.

The board-to-board connector according to the Present application has a configuration such that the first terminal is provided with a flat-plate like contact portion; the second terminal is provided with a pair of contact arm portions and convex contact portions formed in each contact arm portion; and the contact point is an area where the convex contact portions clamps the contact portion from both sides thereof so as to come into contact with each other.

In accordance with the Present application, the board-to-board connector has a configuration in which the perpendicular feet, which are drawn from the contact point of the first and second terminals to the first and second boards, are respectively located within an area for connection of the fixing bracket of the first connector to the first board and within the area for connection of the fixing bracket of the second connector to the second board. Due to this configuration, it is possible to maintain a secure contact state between the first and second terminals even when an external force is applied thereto. Moreover, the first and second connectors are prevented from being removed from the first and second board, respectively. Accordingly, it is possible to provide a board-to-board connector which is capable of facilitating an operation of fitting the first and second connectors so that they are engaged together and providing high reliability thereof.

### BRIEF DESCRIPTION OF THE FIGURES

The organization and manner of the structure and operation of the Present application, together with further objects and advantages thereof, may best be understood by reference to the following Detailed Description, taken in connection with the accompanying Figures, wherein like reference numerals identify like elements, and in which:

FIGS. 1A to 1C are first perspective views illustrating a first connector of a board-to-board connector according to the Present application, in which FIG. 1A is a general view, FIG. 1B is a view illustrating a first auxiliary bracket, and FIG. 1C is a view illustrating a first terminal;

FIGS. 2A to 2D are four planar views illustrating the first connector of FIG. 1, in which FIG. 2A is a rear view, FIG. 2B is a side view, FIG. 2C is a cross-sectional view taken along the arrows A-A in FIG. 2A, and FIG. 2D is a second perspective view;

FIGS. 3A to 3C are perspective views illustrating a second connector of the board-to-board connector according to the Present application, in which FIG. 3A is a general view, FIG. 3B is a view illustrating a second auxiliary bracket, and FIG. 3C is a view illustrating a second terminal;

FIGS. 4A to 4C are three planar views illustrating the second connector of FIG. 3, in which FIG. 4A is a front view, FIG. 4B is a side view, and FIG. 4C is a cross-sectional view taken along the arrows B-B in FIG. 4A;

FIG. 5 is a perspective view illustrating an engagement state of the board-to-board connector according to the Present application;

FIGS. 6A to 6C are three planar views illustrating the engagement state of FIG. 5, in which FIG. 6A is a view seen from a rear surface of the first connector, FIG. 6B is a side view, and FIG. 6C is a cross-sectional view taken along the arrows C-C in FIG. 6A; and

FIG. 7 is a cross-sectional view illustrating a structure of a conventional connector.

### DESCRIPTION OF THE PREFERRED EMBODIMENTS

While the Present application may be susceptible to embodiment in different forms, there is shown in the Figures, and will be described herein in detail, specific embodiments, with the understanding that the disclosure is to be considered an exemplification of the principles of the Present application, and is not intended to limit the Present application to that as illustrated.

In the illustrated embodiments, directional representations—i.e., up, down, left, right, front, rear and the like, used for explaining the structure and movement of the various elements of the Present application, are relative. These representations are appropriate when the elements are in the position shown in the Figures. If the description of the position of the elements changes, however, it is assumed that these representations are to be changed accordingly.

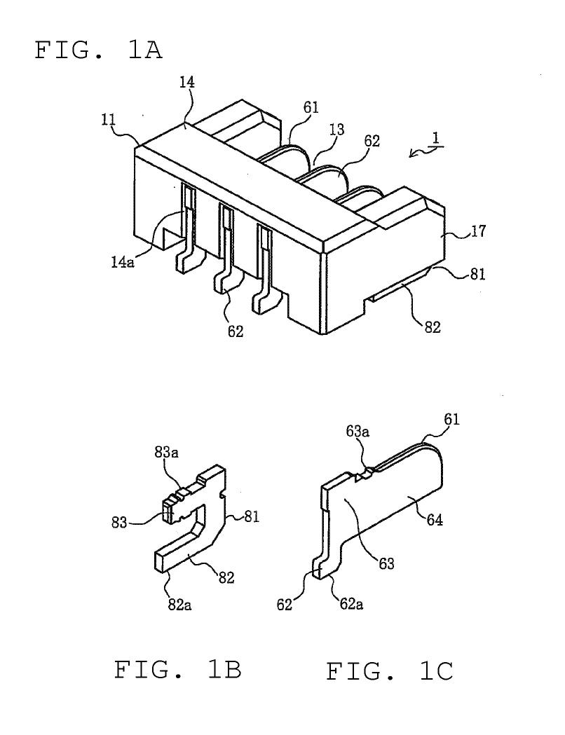

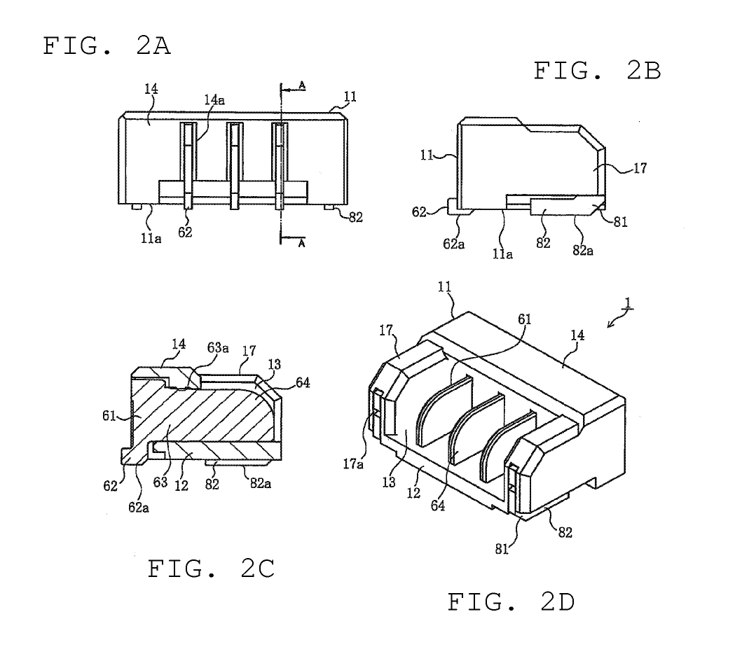

Referring to FIGS. 1-2, a reference numeral 1 denotes a first connector as a board connector in the board-to-board connector, which is to be mounted on a surface of first board as a board not shown and is preferably a low profile type connector having a small height size.

The first connector 1 is engaged, by fitting, with a second connector 101 described later. The second connector 101 is the other board connector of the board-to-board connector and is configured to be mounted on a surface of a second board serving as the other board which is not illustrated. By fitting the first connector 1 and the second connector 101 so that they are engaged together, it is possible to electrically connect the first and second boards together.

The first and second boards are flat plate-like cables which are generally called printed circuit boards, flexible printed circuits (FPC), flexible flat cables (FFC), or the like, and which are used in electronic devices or apparatuses, such as personal computers, cellular phones, personal digital assistants (PDA), digital cameras, video cameras, music players, game machines, or car navigation devices, or electrical devices or apparatuses, for example, consumer electronic appliances, such as digital televisions or DVD players, and may be any type of boards. Throughout this specification, it will be described that the first board is a printed circuit board which is mounted inside a cellular phone or the like to be used as a main board mounting thereon semiconductor devices such as LSI (large scale integrated circuit), and that the second board is a printed circuit board which is attached to a battery pack used as a power source of a cellular phone or the like. In addition, a plane where the top surface of the first board is present and a plane where the top surface of the second board is present are not parallel to each other but intersect each other at a predetermined angle, for example, of 45, 60, 90 or 120 degrees.

Hence, it is to be noted that the first connector 1 is a plug connector including: a first housing 11 which is integrally formed of an insulating material such as a synthetic resin and is mated with a second housing 111 of the second connector 101; a first terminal 61 as a metallic terminal loaded in the first housing 11, and a metallic first auxiliary mounting bracket 81 loaded in the first housing 11 similarly.

The first connector 1 has a dimension of, for example, about 4 mm in length (the left-right dimension in FIG. 2B), about 6 mm in width (the left-right dimension in FIG. 2A), and about 3 mm in thickness (the top-bottom dimension in FIG. 2A). The first terminals 61 are three in number and are arranged at a pitch of about 1 mm. These numerical values may be appropriately changed.

As illustrated in FIGS. 1-2, the first housing 11 includes a flat plate-like bottom wall portion 12 having a generally rectangular shape, a body portion 14 that extends along an edge of the bottom wall portion 12 at a rear end side thereof (a left-lower side in FIG. 1A) so as to stand up from the bottom wall portion 12, and a pair of side wall portions 17 that extend along both side edges of the bottom wall portion 12 so as to stand up from the bottom wall portion 12. A lower surface 11a of the first housing 11 opposes the top surface of the first board. A fitting space 13 is defined above the bottom wall portion 12, the rear end of which is defined by the body portion 14, and both sides of which are defined by the side wall portions 17, in which a part of the second connector 101 is inserted so as to be engaged by fitting therewith.

Moreover, slit-shaped first terminal accommodating recess portion 14a extending the front-rear direction (left-right direction of FIG. 2B) is formed in body portion 14. Further, a first terminal 61 is inserted and loaded in each of the first terminal accommodating recess portions 14a. Although three first terminal accommodating recess portions 14a are provided in the shown example, the number of first terminal accommodating recess portions 14a may be arbitrarily changed so as to correspond to the number of first terminals 61.

As illustrated in FIG. 1C, the first terminal 61 is a flat plate-like member made of a conductive metal, and is provided with an attachment portion 63 that is accommodated in a first terminal accommodating recess portion 14a and secured to the first housing 11, a solder tail portion 62 that extends downward from a rear end of the attachment portion 63, and a flat plate-like contact portion 64 that extends forward from a front end of the attachment portion 63.

The contact portion 64 of the first terminal 61 extends forward from the body portion 14 in a direction so as to stand up from the bottom wall portion 12 and exposed into the fitting space 13. Moreover, a convex engagement portion 63a which is formed in an upper edge of the attachment portion 63 is squeezed into an upper inner wall of the first terminal accommodating recess portion 14a, thus fixing the first terminal 61 to the body portion 14. The solder tail portion 62 of the first terminal 61 has a distal end thereof extending rearward from a lower end of the body portion 14 and has a lower surface thereof which is configured as a securing surface 62a to be electrically connected to counterpart terminal members, such as, for example, signal lines, contact pads, and terminals, formed in the first board, by means of soldering or the like. The solder tail portion 62 of the first terminal 61 functions as a first fixing bracket which is one of the fixing brackets for fixing the first connector 1 to the first board. Moreover, the securing surface 62a corresponds to an area for connection of the first fixing bracket to the first board.

Moreover, each of the side wall portions 17 has formed therein a slit-like first auxiliary bracket accommodating recess portion 17a, and the first auxiliary brackets 81 are inserted and fitted into the first auxiliary bracket accommodating recess portions 17a so as to correspond one-to-one. As illustrated in FIG. 1B, the first auxiliary bracket 81 is a flat plate-like member made of metal having a generally squared C-shaped or U-shaped side form. The first auxiliary bracket 81 is provided with an attachment portion 83 that is accommodated in the first auxiliary bracket accommodating recess portion 17a and fixed to the first housing 11 and a solder tail portion 82 that has an approximately L-shaped side form and extends downward from a front end of the attachment portion 83.

Moreover, convex engagement portions 83a which are formed at upper and lower ends of the attachment portion 83 are squeezed into upper and lower inner walls of the first auxiliary bracket accommodating recess portion 17a, thus fixing the first auxiliary bracket 81 to the side wall portion 17. Furthermore, a lower end portion of the solder tail portion 82 extends in the front-to-rear direction and has a lower surface thereof which is configured as a securing surface 82a to be connected and secured to a counterpart fixing members, such as connection pads, formed in the first board, by means of soldering or the like. Therefore, the securing surface 82a corresponds to an area for connection of the first auxiliary bracket 81 to the first board. The first auxiliary bracket 81 functions as a second fixing bracket which is one of the fixing brackets for fixing the first connector 1 to the first board.

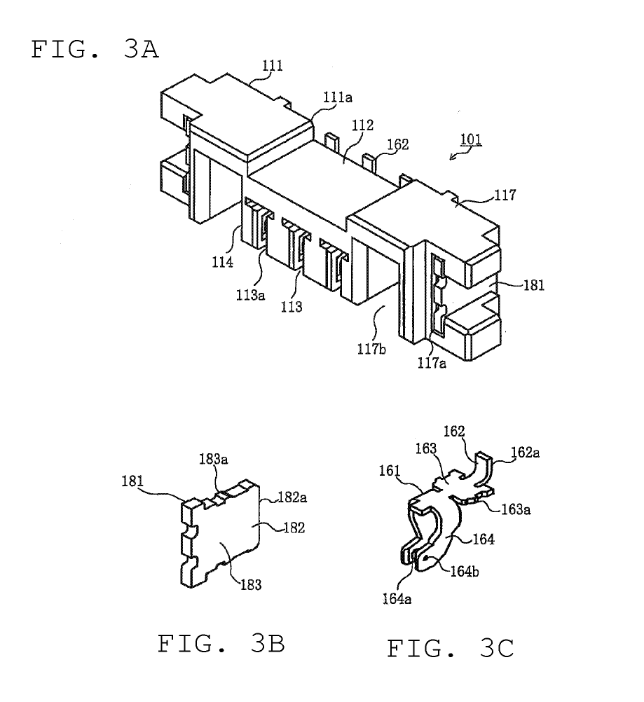

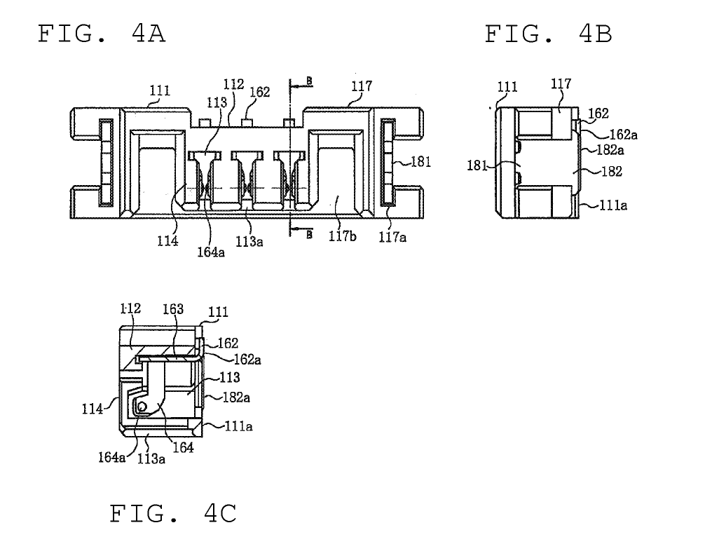

Referring to FIGS. 3-4, it is to be noted that the second connector 101 is a receptacle connector including: a second housing 111 which is integrally formed of an insulating material such as a synthetic resin and is mated with a first housing 11 of the first connector 1; a second terminal 161 as a metallic terminal loaded in the second housing 111, and a metallic second auxiliary mounting bracket 181 loaded in the second housing 111 similarly.

The second connector 101 has a dimension of, for example, about 2.5 mm in length (the left-right dimension in FIG. 4B), about 10 mm in width (the left-right dimension in FIG. 4A), and about 3 mm in thickness (the top-bottom dimension in FIG. 4A). The second terminals 161 are three in number and are arranged at a pitch of about 1 mm. These numerical values may be appropriately changed.

As illustrated in the figures, the second housing 111 includes a flat plate-like top plate portion 112 having a generally rectangular shape, a body portion 114 that has an approximately rectangular shape and is formed so as to stand up from the top plate portion 112 to be integral with a lower surface of the top plate portion 112, and a pair of side wall portions 117 that are connected to be integral with both sides of the top plate portion 112 and the body portion 114. A rear surface 111a of the second housing 111 opposes the top surface of the second board. Moreover, the body portion 114 has at least a part thereof which is inserted and engaged, by fitting, with the fitting space 13 of the first connector 1. Furthermore, a sidewall fitting space 117b is a recess formed in the side wall portion 117, at least the front surface (the left surface in FIG. 4B) and the bottom surface (the lower surface in FIG. 4B) of which are partly opened, in which at least a part of the side wall portion 17 of the first connector 1 is inserted so as to be engaged by fitting therewith.

Moreover, a second terminal accommodating recess portion 113 is formed in body portion 114. Further, a second terminal 161 is inserted and loaded in each of the second terminal accommodating recess portions 113. Although three second terminal accommodating recess portions 113 are provided in the shown example, the number of second terminal accommodating recess portions 113 may be arbitrarily changed so as to correspond to the number of second terminals 161.

As illustrated in FIG. 3C, the second terminal 161 is formed by applying processing, for example, punching or bending, to a conductive metallic plate, and is provided with an attachment portion 163 that is accommodated in the second terminal accommodating recess portion 113 and secured to the second housing 111, a solder tail portion 162 that extends rearward from a rear end of the attachment portion 163, and a pair of contact arm portions 164 that is connected to a front end of the attachment portion 163 so as to extend downward.

The solder tail portion 162 of the second terminal 161 has a distal end thereof extending upward from a rear end of the body portion 114 and has a rear surface thereof which is configured as a securing surface 162a and electrically connected to counterpart terminal members, such as, for example, signal lines, contact pads, and terminals, formed in the second board, by means of soldering or the like. The solder tail portion 162 of the second terminal 161 functions as a third fixing bracket which is one of the fixing brackets for fixing the second connector 101 to the second board. Moreover, the securing surface 162a corresponds to an area for connection of the third fixing bracket to the second board.

In addition, convex engagement portions 163a which are formed at both left and right edges of the attachment portion 163 are squeezed into both left and right inner walls of the second terminal accommodating recess portion 113, thus fixing the second terminal 161 to the body portion 114.

Moreover, each of the contact arm portions 164 is a plate-like member having spring-like properties and an approximately L-shaped side form and has a distal end thereof extending forward and is formed with a convex contact portion 164a at the proximity of the distal end. The convex contact portions 164a are formed on the inner surfaces of the pair of left and right contact arm portions 164 which are arranged in an opposing manner so that apexes thereof oppose each other. In addition, when the convex contact portions 164a are formed, impressions 164b are formed on the outer surfaces of the contact arm portions 164 (which are on the opposite sides of the convex contact portions 164a). The impressions 164b function as contact point indicators that indicate contact points of the convex contact portions 164a and the contact portions 64 of the first terminals 61, as viewed from the outer surfaces of the contact arm portions 164.

Furthermore, continuous slit-like terminal accommodation openings 113a which are in communication with the lower and front ends of the second terminal accommodating recess portions 113 are formed in the lower and front surfaces of the body portion 114 at positions close to the front surface. When the first connector 1 and the second connector 101 are connected by being fitted together, the contact portions 64 of the first terminals 61 come into the second terminal accommodating recess portions 113 through the terminal accommodation openings 113a. In the second terminal accommodating recess portion 113, the pair of left and right convex contact portions 164a of the second terminal 161 oppose each other at a close distance as illustrated in FIG. 4A. For this reason, the plate-like contact portion 64 of the first terminal 61 comes to be positioned between the pair of left and right convex contact portions 164a so as to increase the distance between the pair of left and right contact arm portions 164 having spring-like properties. Therefore, the contact portion 64 of the first terminal 61 is clamped by the contact arm portions 164 from both left and right surfaces thereof, and the apexes of the pair of left and right convex contact portions 164a are squeezed into both left and right surfaces of the contact portion 64, whereby secure contact between the first terminal 61 and the second terminal 161 is achieved.

Moreover, each of the side wall portions 117 has formed therein a slit-like second auxiliary bracket accommodating recess portion 117a, and the second auxiliary brackets 181 are inserted and fitted into the second auxiliary bracket accommodating recess portions 117a so as to correspond one-to-one. As illustrated in FIG. 3B, the second auxiliary bracket 181 is a flat plate-like member made of metal having a generally rectangular side form. The second auxiliary bracket 181 is provided with an attachment portion 183 that is accommodated in the second auxiliary bracket accommodating recess portion 117a and fixed to the second housing 111 and a solder tail portion 182 that is connected to a front end of the attachment portion 183.

Moreover, convex engagement portions 183a which are formed at upper and lower ends of the attachment portion 183 are squeezed into upper and lower inner walls of the second auxiliary bracket accommodating recess portion 117a, thus fixing the second auxiliary bracket 181 to the side wall portion 117. Furthermore, a rear end portion of the solder tail portion 182 extends in the front-to-rear direction and has a rear surface thereof which is configured as a securing surface 182a to be connected and secured to a counterpart fixing members, such as connection pads, formed in the second board, by means of soldering or the like. Therefore, the securing surface 182a corresponds to an area for connection of the second auxiliary bracket 181 to the second board. The second auxiliary bracket 181 functions as a fourth fixing bracket which is one of the fixing brackets for fixing the second connector 101 to the second board.

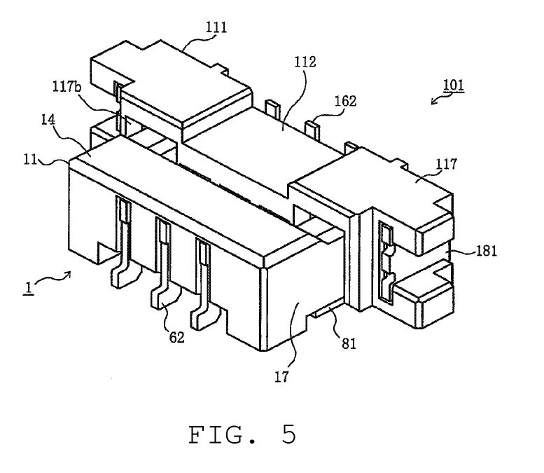

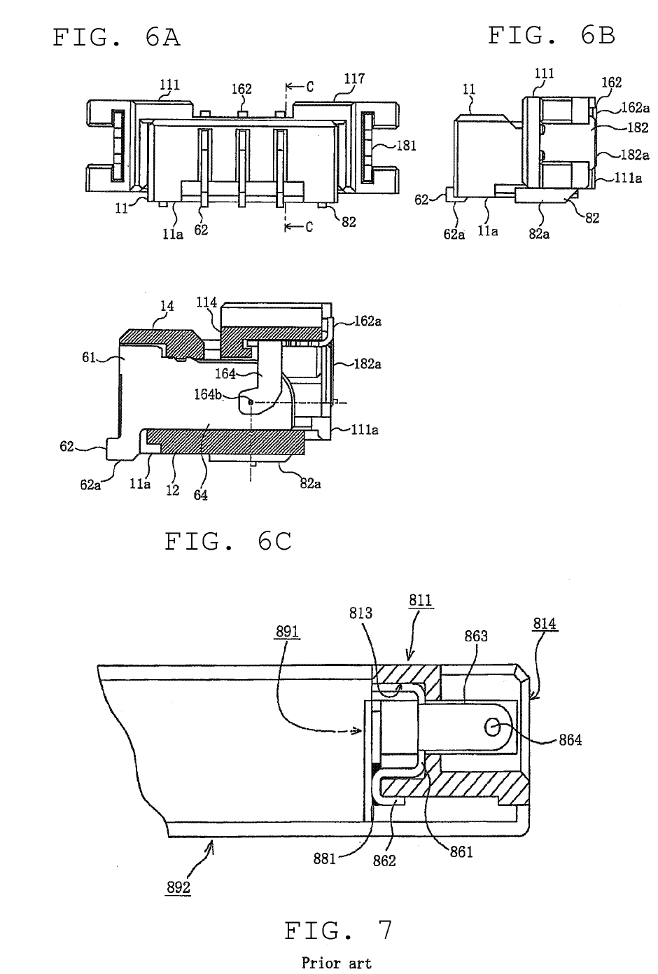

Referring to FIGS. 5-6, it will be assumed that the first connector 1 already has been mounted on the surface of the first board in such a way that the lower surface 11a of the first housing 11 opposes the top surface of the first board. Specifically, the solder tail portions 62 of the first terminals 61 are connected, by means of soldering or the like, to the counterpart terminal members connected to a non-illustrated conductive trace on the first board, and the solder tail portions 82 of the first auxiliary brackets 81 are connected, by means of soldering or the like, to the fixing members on the first board. The securing surface 82a of the solder tail portion 82 corresponds to the area for connection of the first auxiliary bracket 81 to the first board.

Similarly, it will be assumed that the second connector 101 already has been mounted on the surface of the second board in such a way that the rear surface 111a of the second housing 111 opposes the top surface of the second board. Specifically, the solder tail portions 162 of the second terminals 161 are connected, by means of soldering or the like, to the connection pads connected to a non-illustrated conductive trace on the second board, and the solder tail portions 182 of the second auxiliary brackets 181 are connected, by means of soldering or the like, to the fixing members on the second board. The securing surface 182a of the solder tail portion 182 corresponds to the area for connection of the second auxiliary bracket 181 to the second board.

First, an operator adjusts the positions of the first connector 1 and the second connector 101 so that the upper surface of the first connector 1 opposes the lower surface of the second connector 101, the fitting space 13 of the first connector 1 opposes the body portion 114 of the second connector 101, and the left and right side wall portions 17 of the first connector 1 oppose the left and right sidewall fitting spaces 117b of the second connector 101.

Then, the second connector 101 is lowered relative to the first connector 1 so that the body portion 114 of the second connector 101 is inserted into the fitting space 13 of the first connector 1, and the left and right side wall portions 17 of the first connector 1 are inserted into the left and right sidewall fitting spaces 117b of the second connector 101. In this way, the first connector 1 and the second connector 101 are engaged, by fitting, with each other as illustrated in FIG. 5 and FIGS. 6A to 6C.

At this time, the contact portion 64 of the first terminal 61 of the first connector 1 is raised relative to the second connector 101 so as to pass through the terminal accommodation opening 113a from the lower side of the body portion 114 of the second housing 111 and finally come into the second terminal accommodating recess portion 113. Moreover, in the second terminal accommodating recess portion 113, the convex contact portion 164a of the contact arm portion 164 of the second terminal 161 is positioned at a portion which corresponds to an upper portion of the terminal accommodation opening 113a formed close to the distal end of the body portion 114. Therefore, the contact portion 64 of the first terminal 61 coming into the second terminal accommodating recess portion 113 through the terminal accommodation opening 113a comes to be positioned between the left and right convex contact portions 164a from the lower side.

Since the contact portion 64 is clamped by the left and right contact arm portions 164, the first terminal 61 and the second terminal 161 are placed in position so as to make electrical contact with each other. At this time, since the left and right convex contact portions 164a are squeezed into both left and right surfaces of the contact portion 64, secure contact between the first terminal 61 and the second terminal 161 is maintained. Therefore, the conductive trace of the first board can be electrically securely connected to the conductive trace of the second board via the first terminal 61 and the second terminal 161.

As illustrated in FIG. 6B, in an engagement state of the first connector 1 and the second connector 101, the lower surface 11a of the first housing 11 and the rear surface 111a of the second housing 111 are substantially perpendicular to each other. Therefore, the first board opposing the lower surface 11a of the first housing 11 and the second board opposing the rear surface 111a of the second housing 111 are substantially perpendicular to each other. That is to say, the plane where the first board is present and the plane where the second board is present are not parallel to each other but intersect each other at an angle of about 90 degrees. For sake of explanation, although only the case where the plane where the first board is present and the plane where the second board is present intersect each other at an angle of about 90 degrees is described, the angle may be appropriately changed as necessary.

As illustrated in FIG. 6C, as viewed in a side view of the first connector 1 and the second connector 101, the perpendicular feet, which are drawn from the impression 164b serving as the contact point indicator that indicates the contact point of the convex contact portion 164a and the contact portion 64 of the first terminal 61 to the first and second boards, are respectively located within a range of areas extending from a distal end (the left end in the figure) of the securing surface 62a of the solder tail portion 62 of the first terminal 61 to a distal end (the right end in the figure) of the securing surface 82a of the solder tail portion 82 of the first auxiliary bracket 81, and within a range of areas extending from a distal end (the upper end in the figure) of the securing surface 162a of the solder tail portion 162 of the second terminal 161 to a distal end (the lower end in the figure) of the securing surface 182a of the solder tail portion 182 of the second auxiliary bracket 181. That is to say, the perpendicular feet, which are drawn from a contact point of the first terminal 61 and the second terminal 161 to the first and second boards, are respectively located within an area for connection of the first and second fixing brackets serving as the fixing brackets of the first connector 1 to the first board and within an area for connection of the third and fourth fixing brackets serving as the fixing brackets of the second connector 101 to the second board, as viewed in the side view of the first connector 1 and the second connector 101.

More specifically, as viewed in the side view of the first connector 1 and the second connector 101, the perpendicular feet, which are drawn from the impression 164b serving as the contact point indicator that indicates the contact point of the convex contact portion 164a and the contact portion 64 of the first terminal 61, are respectively located within a range of areas of the securing surface 82a of the solder tail portion 82 of the first auxiliary bracket 81 and within a range of areas of the securing surface 182a of the solder tail portion 182 of the second auxiliary bracket 181. That is to say, the perpendicular feet, which are drawn from the contact point of the first terminal 61 and the second terminal 161 to the first and second boards, are respectively located within an area for connection of the second fixing bracket of the first connector 1 to the first board, and within an area for connection of the fourth fixing bracket of the second connector 101 to the second board, as viewed in the side view of the first connector 1 and the second connector 101.

As described above, the perpendicular foot, which is drawn from the contact point of the first terminal 61 and the convex contact portion 164a of the second terminal 161 to the first board, is located within a range of areas extending from the distal end of the securing surface 62a of the solder tail portion 62 of the first terminal 61 of the first connector 1 to the distal end of the securing surface 82a of the solder tail portion 82 of the first auxiliary bracket 81. Due to this configuration, even when an external force capable of disengaging the second connector 101 from the first connector 1 is applied to the second connector 101, and thus an urging force perpendicular to the first board is applied to the contact point of the first terminal 61, no rotational moment will be generated. Therefore, the securing surface 62a of the first terminal 61 and the securing surface 82a of the first auxiliary bracket 81 will be prevented from being separated from the first board, and thus the first connector 1 will be prevented from being removed from the first board.

Similarly, the perpendicular foot, which is drawn from the contact point of the second terminal 161 and the contact portion 64 of the first terminal 61 to the second board, is located within a range of areas extending from the distal end of the securing surface 162a of the solder tail portion 162 of the second terminal 161 of the second connector 101 to the distal end of the securing surface 182a of the solder tail portion 182 of the second auxiliary bracket 181. Due to this configuration, even when an external force capable of disengaging the first connector 1 from the second connector 101 is applied to the first connector 1, and thus a leftward urging force, in FIG. 6B, perpendicular to the second board is applied to the contact point of the second terminal 161, no rotational moment will be generated. Therefore, the securing surface 162a of the second terminal 161 and the securing surface 182a of the second auxiliary bracket 181 will be prevented from being separated from the second board, and thus the second connector 101 will be prevented from being removed from the second board.

As illustrated in FIG. 1C, the first terminal 61 is provided with the solder tail portion 62 that extends downward from the rear end of the attachment portion 63 and the flat plate-like contact portion 64 that extends forward from the front end of the attachment portion 63. That is to say, the first terminal 61 has a shape such that the contact portion 64 is disposed at a position distant from the solder tail portion 62 that functions as the first fixing bracket for fixing the first connector 1 to the first board. Due to this configuration, if the first auxiliary bracket 81 is not present, when an upward urging force perpendicular to the first board is applied to the contact point of the first terminal 61, a rotational moment will act on the solder tail portion 62. However, the first connector 1 has the first auxiliary bracket 81 serving as the second fixing bracket, and the perpendicular foot, which drawn from the contact point of the first terminal 61 and the second terminal 161 to the first board, is located within the range of areas of the securing surface 82a of the solder tail portion 82 of the first auxiliary bracket 81. Therefore, even when the solder tail portion 62 of the first terminal 61 is disposed at a position distant from the contact portion 64, no rotational moment will be generated, and thus the first connector 1 is prevented from being removed from the first board.

Similarly, as illustrated in FIG. 3C, the second terminal 161 is provided with the solder tail portion 162 that extends upward from the rear end of the attachment portion 163 and the contact arm portion 164 that extends downward from the front end of the attachment portion 163. That is to say, the second terminal 161 has a shape such that the convex contact portion 164a is positioned at a position distant from the solder tail portion 162 that functions as the third fixing bracket for fixing the second connector 101 to the second board. Due to this configuration, if the second auxiliary bracket 181 is not present, when a leftward urging force perpendicular to the second board is applied to the contact point of the second terminal 161, a rotational moment will act on the solder tail portion 162. However, the second connector 101 has the second auxiliary bracket 181 serving as the fourth fixing bracket, and the perpendicular foot, which is drawn from the contact point of the first terminal 61 and the second terminal 161 to the second board, is located within the range of areas of the securing surface 182a of the solder tail portion 182 of the second auxiliary bracket 181. Therefore, even when the solder tail portion 162 of the second terminal 161 is disposed at a position distant from the convex contact portion 164a, no rotational moment will be generated, and the second connector 101 is prevented from being removed from the second board.

As described above, the board-to-board connector includes the first connector 1 having the first housing 11 made of an insulating material and the first terminal 61 fitted in the first housing 11, the first connector 1 being configured to be mounted on the first board; and the second connector 101 having the second housing 111 made of an insulating material and the second terminal 161 fitted in the second housing 111 and configured to make contact with the first terminal 61, the second connector 101 being configured to be mounted on the second board so as to be engaged with the first connector 1. When the first connector 1 and the second connector 101 are engaged together so that a plane where the first board is present intersects a plane where the second board is present, the perpendicular feet, which are drawn from the contact point of the first terminal 61 and the second terminal 161 to the first and second boards, are respectively located within the area for connection of the fixing bracket of the first connector 1 to the first board and within the area for connection of the fixing bracket of the second connector 101 to the second board, as viewed in the side view of the first connector 1 and the second connector 101.

Due to this configuration, it is not only possible to maintain a secure contact state between the first terminal 61 and the second terminal 161 even when an external force is applied thereto, but also to improve reliability of the board-to-board connector that connects the first board and the second board which are arranged so as to intersect each other. Moreover, even when the first board and the second board are arranged so as to intersect each other, the first connector 1 and the second connector 101 are prevented from being removed from the first board and the second board, respectively. Furthermore, it is possible to facilitate the operation of fitting the first connector 1 and the second connector 101 so that they are engaged together.

Moreover, the fixing bracket of the first connector 1 includes the first fixing bracket and the second fixing bracket which are fitted to the first housing 11, and the area for connection of the fixing bracket to the first board is a range of areas that extends from the distal end of the area for connection of the first fixing bracket to the first board to the distal end of the area for connection of the second fixing bracket to the first board, as viewed in the side view of the first connector 1. In addition, the fixing bracket of the second connector 101 includes the third fixing bracket and the fourth fixing bracket which are fitted to the second housing 111, and the area for connection of the fixing bracket to the second board is an area that extends from the distal end of the area for connection of the third fixing bracket to the second board to the distal end of a area for connection of the fourth fixing bracket to the second board, as viewed in the side view of the second connector 101. Due to this configuration, since the area for connection of the fixing bracket to the first board and the area for connection of the fixing bracket to the second board are wide, there is a high degree of freedom as to the location of the contact point of the first terminal 61 and the second terminal 161. Thus, there is a high degree of freedom for the design of the first and second terminals 61 and 161 and the first and second housings 11 and 111.

Furthermore, the first fixing bracket is the solder tail portion 62 of the first terminal 61, and the second fixing bracket is a part of the first auxiliary bracket 81 fitted to the first housing 11. The third fixing bracket is the solder tail portion 162 of the second terminal 161, and the fourth fixing bracket is a part of the second auxiliary bracket 181 fitted to the second housing 111. The perpendicular feet, which are drawn from the contact point of the first terminal 61 and the second terminal 161 to the first and second boards, are respectively located within the area for connection of the first auxiliary bracket 81 to the first board and within the area for connection of the second auxiliary bracket 181 to the second board. Due to this configuration, even when the solder tail portion 62 of the first terminal 61 and the solder tail portion 162 of the second terminal 161 are disposed at a position distant from the contact point of the first terminal 61 and the second terminal 161, no rotational moment will be generated. Therefore, the first connector 1 and the second connector 101 are prevented from being removed from the first and second boards, respectively.

While a preferred embodiment of the Present application is shown and described, it is envisioned that those skilled in the art may devise various modifications without departing from the spirit and scope of the foregoing Description and the appended Claims.

What is claimed is:

1. A board-to-board connector comprising:
a first connector, the first connector having a first housing and a first terminal, the first terminal being fitted in the first housing, the first connector being configured to be mounted on a first board; and
a second connector, the second connector having a second housing and a second terminal, the second terminal being fitted in the second housing and being configured to make contact with the first terminal, the second connector being configured to be mounted on a second board so as to be engaged with the first connector;
wherein when the first connector and the second connector are engaged together so that a plane where the first board is present intersects a plane where the second board is present.

2. The board-to-board connector of claim 1, wherein perpendicular feet, which are drawn from a contact point of the first and second terminals to the first and second boards, are respectively located within an area for connection of a fixing bracket of the first connector to the first board and within an area for connection of a fixing bracket of the second connector to the second board, as viewed in a side view of the first and second connectors.

3. The board-to-board connector of claim 2, wherein the first terminal includes a flat-plate like contact portion, and the second terminal includes a pair of contact arm portions.

4. The board-to-board connector of claim 3, wherein the second terminal further includes convex contact portions formed in each contact arm portion.

5. The board-to-board connector of claim 4, wherein the contact point is an area where the convex contact portions clamp the contact portion from both sides thereof so as to come into contact with each other.

6. The board-to-board connector of claim 2, wherein the fixing bracket of the first connector includes a first fixing bracket and a second fixing bracket, each of which are fitted to the first housing.

7. The board-to-board connector of claim 6, wherein the area for connection of the fixing bracket to the first board is an area that extends from a distal end of an area for connection of the first fixing bracket to the first board to a distal end of an area for connection of the second fixing bracket to the first board, as viewed in the side view of the first connector.

8. The board-to-board connector of claim 7, wherein the fixing bracket of the second connector includes a third fixing bracket and a fourth fixing bracket which are fitted to the second housing.

9. The board-to-board connector of claim 8, wherein the area for connection of the fixing bracket to the second board is an area that extends from a distal end of an area for connection of the third fixing bracket to the second board to a distal end of an area for connection of the fourth fixing bracket to the second board, as viewed in the side view of the second connector.

10. The board-to-board connector of claim 9, wherein the first terminal includes a flat-plate like contact portion, and the second terminal includes a pair of contact arm portions.

11. The board-to-board connector of claim 10, wherein the second terminal further includes convex contact portions formed in each contact arm portion.

12. The board-to-board connector of claim 11, wherein the contact point is an area where the convex contact portions clamp the contact portion from both sides thereof so as to come into contact with each other.

13. The board-to-board connector of claim 8, wherein the first fixing bracket is a solder tail portion of the first terminal.

14. The board-to-board connector of claim 13, wherein the second fixing bracket is a part of the first auxiliary bracket fitted to the first housing.

15. The board-to-board connector of claim 14, wherein the third fixing bracket is a solder tail portion of the second terminal.

16. The board-to-board connector of claim 15, wherein the fourth fixing bracket is a part of the second auxiliary bracket fitted to the second housing.

17. The board-to-board connector of claim 16, wherein the perpendicular feet are respectively located within an area for connection of the first auxiliary bracket to the first board and within an area for connection of the second auxiliary bracket to the second board.

18. The board-to-board connector of claim 17, wherein the first terminal includes a flat-plate like contact portion, and the second terminal includes a pair of contact arm portions.

19. The board-to-board connector of claim 18, wherein the second terminal further includes convex contact portions formed in each contact arm portion.

20. The board-to-board connector of claim 19, wherein the contact point is an area where the convex contact portions clamp the contact portion from both sides thereof so as to come into contact with each other.
